(19) United States
(12) Patent Application Publication
(10) Pub. No.: US 2005/0268607 A1
(43) Pub. Date: Dec. 8, 2005

(54) Thermohydrodynamic power amplifier

(76) Inventors: Jurgen Kleinwachter, Kandern (DE); Eckhart Weber, Nurnberg (DE); Oliver Paccoud, Breitenbach (FR)

Correspondence Address: WILLIAM COLLARD;COLLARD & ROE, P.C., 1077 NORTHERN BOULEVARD, ROSLYN, NY, 11576, US

(21) Appl. No.: 10/526,585

(22) PCT Filed: Aug. 20, 2003
(86) PCT No.: PCT/DE03/02810

§ 371 Date: Jul. 15, 2005

(30) Foreign Application Priority Data
Sep. 2, 2002 (DE) 102 40 924.2

(51) Int. Cl. F03C 5/00

(52) U.S. Cl. 60/530

(57) ABSTRACT

A thermodynamic force amplifying machine that causes a liquid working medium to perform useful work in a three-stroke working cycle (isochoric heating, isothermal expansion, contraction through regenerative cooling) making use of an external heat source and of an external cold source. The work performed by the auxiliary drive (12) at the displacer (11) is thereby much smaller than the one produced in the conversion system (18, 19) (force amplification). An inversely operating machine driven by an external power source acts as a heat pump/refrigerator.

As compared to gases, liquids are virtually incompressible, expand less with heat, have considerably higher specific heat capacity and offer the possibility of improved heat exchange. In the mid 20ies of the previous century, J. F. Malone from Newcastle upon Tyne (England) tried to utilize liquids instead of working gas in thermal engines.

He developed a regenerative machine that was similar to the hot gas Stirling machine but was filled, instead of air, with pressurized water as the working medium. (U.S. Pat. No. 1,487,664 of Mar. 18, 1924 and U.S. Pat. No. 1,717,161 of Jun. 11, 1929).

He could prove that, at a temperature difference of 305 K, he achieved an efficiency of 27% which corresponds to a considerable percentage of performance of the ideal Camot cycle of 54%, thus being approximately double that of the then current steam engines.

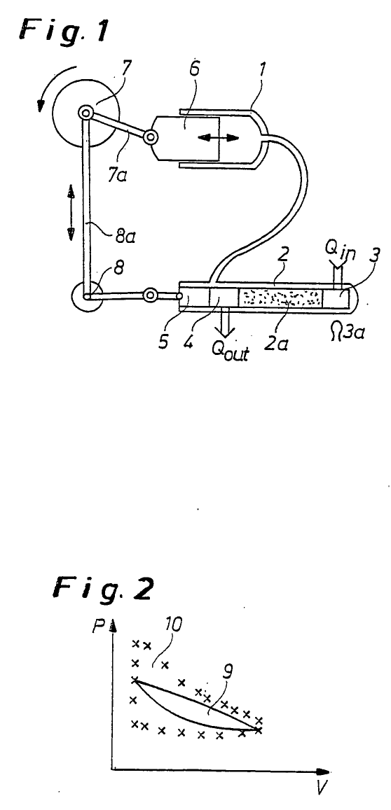

The reason for this good efficiency was due to the fact that, like the Stirling machine, the machine was equipped with a heat regenerator and additionally made use of the considerably improved heat transfer properties of liquids over gases. The Malone machine is schematically illustrated in FIG. 1. (1) thereby refers to the working cylinder, (2) to the displacer cylinder, (3) to the heater that is constantly heated by an external (flame) heat source (3a), (4) to the cooler, (5) to the displacer piston that displaces the regenerator (2a) from hot to cold so as to be 90 degrees out of phase with the working piston (6). The working piston (6), which is connected to the flywheel (7) via the connecting rod (7a), transfers the oscillating movement out of phase to the regenerator path (2a) via the secondary connecting rod (8a) and the eccentric (8).

FIG. 2 is a PV diagram showing both an ideal Stirling cycle (10) and the cycle (9) performed by the Malone machine.

Since water only remains liquid in the required working temperature range when pressurized to very high pressure levels of >100 bar, Malone had to use cylinders that were very pressure-resistant. As he moreover fell back upon crankshafts and working pistons to convert the pressure fluctuations thermally generated in the liquid into rotating shaft energy, he submitted the liquid, like with conventional working machines, to a working cycle in which useful work is delivered through the working piston and the crankshaft-flywheel system during the (hot) expansion phase, whilst work originating from part of the expansion work stored in the flywheel has to be brought into the system during the (cold) recompression phase.

Since liquids are virtually incompressible as compared to gases or to liquid-vapor mixtures, the working pistons, the displacer, the crankshaft and the flywheel will unavoidably impress on the fluid as a result of the rigid forced coupling, extremely high pressures being more specifically inevitably generated during the recompression phase. This results in very high loads due to pressure changes and requires very high flywheel masses that in turn transmit heavy dynamic loads onto the bearings and the overall structure.

As a result, the fundamental advantages of the Malone machine (substantially improved heat transfer properties, high heat capacity and, as a result thereof, power density over gases) were thwarted by the life-limiting pressure fluctuations resulting from this building principle. Therefore these machines failed to find acceptance in daily practice in spite of their superior thermodynamics.

It is therefore the object of the present invention to make use of the fundamental advantages already found out by Malone of a liquid used as the thermodynamic working fluid in a novel engineering design in such a manner that the negative aspects described will no longer arise.

The machine of the invention described herein after acts as a thermo-hydrodynamic force amplifier (THFA).

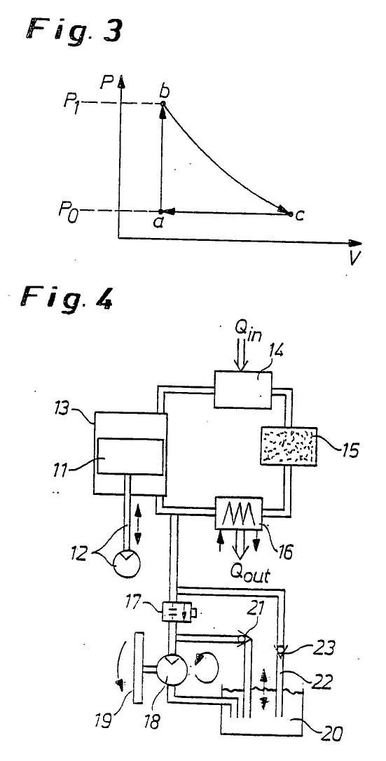

In the PV-diagram (FIG. 3), the THFA performs a cycle that is fundamentally different from that of classical thermal engines. The liquid is thereby isochorically heated from a to b. Therefore, the initial pressure P₀ corresponds to the ambient pressure (or to a slightly elevated pressure). As soon as the desired pressure P₁ is achieved in the liquid, a shut-off element (17) opens and the liquid expands, producing work at a system mounted downstream thereof (hydraulic engine, compressor piston, and so on). This expansion occurs until the initial pressure Po is again achieved at e, with the volume being greater and the temperature higher than in the initial state a. As contrasted with classical machines in which the fluid is returned to the initial state a by mechanical recompression, the THFA relies on heat abstraction for causing the liquid to contract. In accordance with the invention, the great advantage thereof is that, since all the useful energy is withdrawn from b to c during the expansion phase, no mechanical energy must be stored temporarily in any manner (flywheel, air chamber, and so on). This principle further offers the possibility, in accordance with the invention, of completely dispensing with a crankshaft mechanism exerting constraining forces onto the fluid, as will be discussed herein after.

If a regenerator or a recuperator is additionally incorporated into the heat exchange process during the working phases a→b and c→a and if the expansion of the fluid is isothermal, the working process determined by the corner points a, b, c is thermodynamically ideal except for irreversible losses in the fluid and for heat losses.

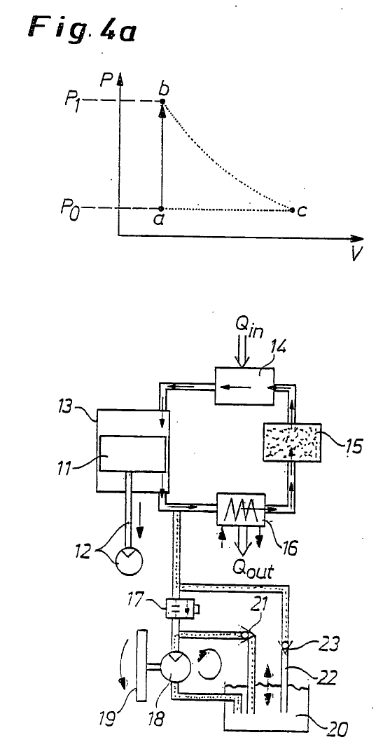

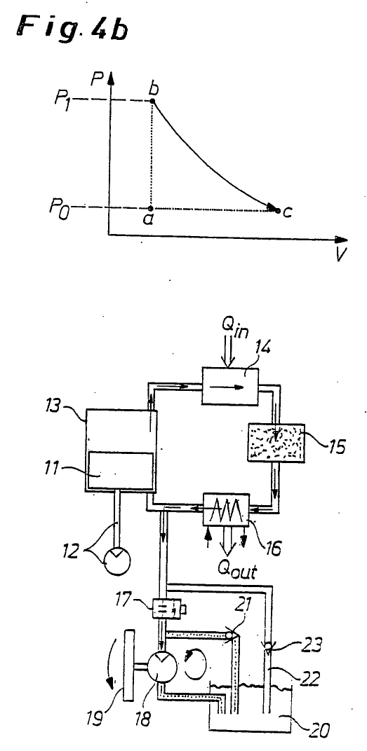

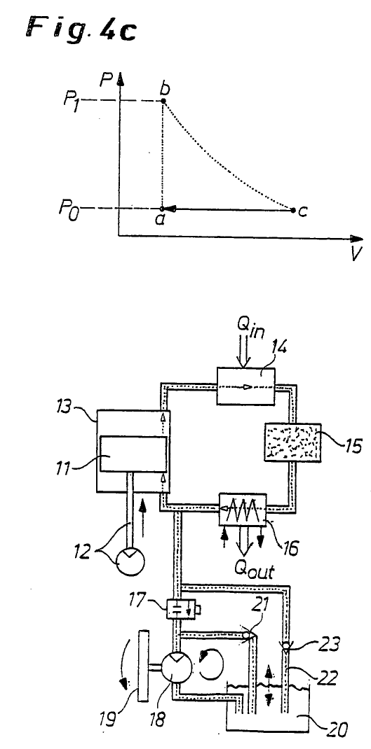

FIG. 4 illustrates the basic configuration of a THFA combined with a hydraulic engine.

(11) thereby refers to the displacer piston that is moved up and down within the pressure cylinder (13) by a linear drive (12). It cyclically causes the working fluid to move back and forth on a heater (14), regenerator (15) and cooler (16) path. A hydraulic valve serves as the switchable shut-off element (17). At the beginning of the cycle (FIG. 3, path a→b), said shut-off element is closed when the displacer piston moves downward, thus transferring the liquid to the hot side of the system. As the desired pressure P₁ is achieved at point b of the PV-diagram, the valve opens and the liquid expands at high pressure, the hydraulic engine (18) to which the flywheel (19) is coupled producing work. The expanded fluid next collects in the collector tank (20). A circulation line having the check valve (21) ensures constant circulation of the fluid from the collector tank through the hydraulic engine as long as the latter is in operation. Once the work-producing expansion of the fluid (point c in the PV diagram, FIG. 3) is completed, the valve (17) is caused to close; the displacer (11) moves upward and displaces the fluid to the cold side of the system (path c→a in FIG. 3). The fluid, which is cooling down, contracts toward the initial point a of the cycle (FIG. 3), thereby drawing fluid from the collector tank (20) via the conduit (22) and the check valve (23).

As hot and cold fluid is caused to flow in alternating directions through the regenerator (15), the latter temporarily stores heat almost without any entropy loss (because heat and cold are reclaimed along a linear temperature profile) and returns said heat to the fluid when the right time arrives for that event to happen.

In selecting the appropriate oscillation frequency of the displacer (11) and the right dimensions of the cross sections of flow through the heater regenerator cooler path, one achieves that the quantity of work produced by the expanding liquid is increased many times over as compared to the work produced by the displacer piston. Therefore, and because of the way it operates, we call the machine of the invention a Thermo-Hydrodynamic Force Amplifier (THFA).

For better understanding of the invention, the FIGS. 4a, 4b, 4c once more illustrate schematically the three working strokes that are allocated to the corresponding section in the PV diagram.→thereby represents the pressurized fluid flow, - - - →the motionless pressurized fluid, • • • • • →fluid motion at low pressure.

In FIG. 4a, the fluid is isochorically compressed. The displacer piston (11), which is driven by the linear drive (12), is on its way downward. The hydraulic valve (17) is closed. Travel occurs along path a→b. The level of the fluid in the expansion tank (20) is at its lowest.

In FIG. 4b, the displacer piston (11) has reached the bottom dead center. The linear drive (12) stands still. The hydraulic valve (17) has opened. In the PV diagram, travel occurs along path b→c. The hydraulic engine (18) is driven by the expanding liquid. The fluid level in the expansion tank (20) rises.

In FIG. 4c, the displacer piston (11) is caused to move upward by the linear drive (12). The hydraulic valve (17) is closed. The non-pressurized hot fluid is cooled down to the initial temperature through the regenerator (15) and the cooler (16), thus experiencing a contraction. The thus generated negative pressure draws fluid from the expansion tank (20) via the conduit (22). The fluid in said expansion tank drops to its lowest level. In the PV diagram, travel occurs along path c→a. At this point, the initial state a of the cycle is reached once more.

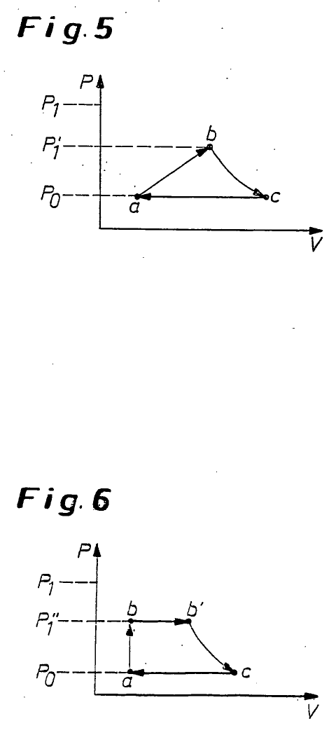

The basic functioning principle of a three cycle THFA machine described heretobefore may be varied in a variety of ways. In accordance with the invention, one possibility consists in using the pressure built up by the very hydraulic engine (18) instead of the hydraulic valve (17). Said pressure build-up is due to the fact that the absorption volume of the hydraulic engine (18) is chosen to be much smaller than the volume flow of the fluid created by the fluid being heated on the path a→b in the PV diagram. FIG. 5 illustrates a PV diagram resulting from such a THFA process. In accordance with the invention, the process is re-started when the fluid is at the pressure state P₀. The medium, which expands as a result of the fluid being displaced from cold to hot, flows through the hydraulic engine (17) with the pressure increasing until at P′₁ at b the displacer piston (11) has reached its bottom dead center. Next, with the displacer piston being retained, the fluid expands to point c at P₀ prior to being caused to contract from c→a by regenerative cooling. The hydraulic valve (17) is closed during the cycle portion a→b→c and opened from c→b.

Although such a variant of the THFA is less efficient in each cycle, it is characterized by particularly smooth, continuous running and needs less resistance to pressure as a result of the reduced maximum pressure.

Another advantageous design possibility consists in combining the shut-off properties of the hydraulic valve (17) and of the hydraulic engine. FIG. 6 illustrates the indicator diagram of such a THFA variant. The fluid, which initially is at pressure P₀, is isochorically compressed to the intermediate pressure P₁ (valve 17 is closed). From b to b′, the fluid expands isobarically through the hydraulic engine (18) (valve 18 is open). After the displacer piston (11) has reached its bottom dead center, the fluid expands from b′ to c (valve 18 is open). Then, the fluid is caused to contract back from c to the initial state a through reversible heat abstraction with the valve (18) being closed. Such a variant of the THFA achieves good cycle performance and saves the pressure cylinders as a result of the reduced maximum pressure as compared to the basic variant.

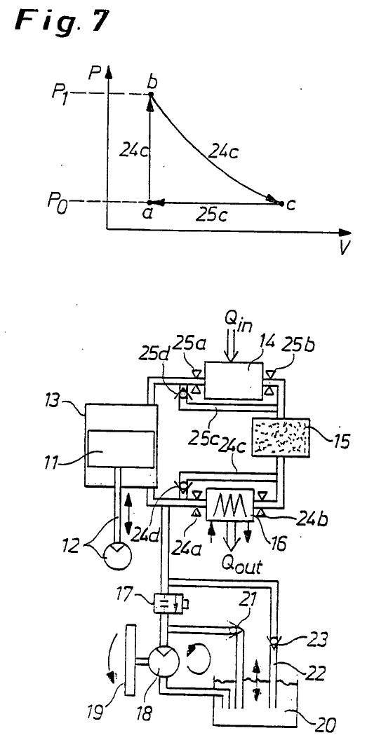

Another advantageous design of the THFA of the invention resides in the possibility of integrating the heater (14) and the cooler (16) into the fluid circuit only during the working cycle portions in which their respective function is needed. On the one side, this minimizes the negative effects of fluid dead volume and on the other side it permits to design the flow-through cross sectional areas of the heater and the cooler without adverse effects onto the cycle with regard to a small dynamic through flow resistance and optimum heat transfer properties. FIG. 7 schematically illustrates the corresponding necessary bypass lines with shut-off valves and their timing in the PV diagram.

During displacement of the fluid from a→b by the displacer piston, meaning during heating of the fluid, it is not desirable that heat be abstracted by the cooler (16). By causing the valves (24a, 24b) to close, the fluid is carried around the cooler in a bypass (24c) prior to being caused to flow through the regenerator (15) and the heater (14). During subsequent expansion of the fluid from b→c, cooling is not desirable (24a, 24b are still closed, fluid flows through 24c).

Subsequent heating by the heater (14) is desirable because of the isothermal expansion one wants to achieve from b→c. From a→b→c, the fluid flows through bypass (24c); this is denoted in the PV diagram. When the fluid is next reversibly cooled from c→a, contracting as a result thereof, only the action of the cooler (16) is desirable, not that of the heater (14), though. Therefore, the heater is shut off by the two valves 25a, 25b and the fluid is conducted directly through the regenerator (15) and the cooler (16) via bypass (25c) (valves 24a, 24b are open again). In order for the fluid to flow through (16) and (14) respectively when the shut-off valves 24a, 24b and 25a, 25b respectively are open, the bypass lines 24c and 25c are fitted with the check valves 24d and 25d.

Heretobefore, THFA machines have been described in which rotation decoupling is performed by the hydraulic engine. Since the cycle energy decreases constantly during expansion of the working fluid it is necessary to “conform” this unsteady performance. With rotating machines, this is best achieved using a suited flywheel (19).

As a result of the fact that on the one side energy is delivered to the outside during the expansion phase only and that on the other side the working frequency of the THFA machine should be as low as possible for reasons of efficiency, the flywheel has not only to conform to the unsteady energy supply during expansion but must also bridge quite long time gaps during which the machine does not release any energy. By nature, this results in large flywheels.

Therefore, another design in accordance with the invention of the THFA-machine is to implement it as a multicylinder machine (number n of cylinders≧2) and to time the linear drives (12) of the various cylinders in such a manner that the resulting overlap of the cycles results in a smooth drive torque. This leads to substantially smaller flywheels.

In accordance with the invention though, the purely translatory movement of the expanding and contracting column of liquid is intended to be used for driving subsystems such as typically: air compressors, heat pumps-refrigerators, -compressors, reverse osmosis systems and the like.

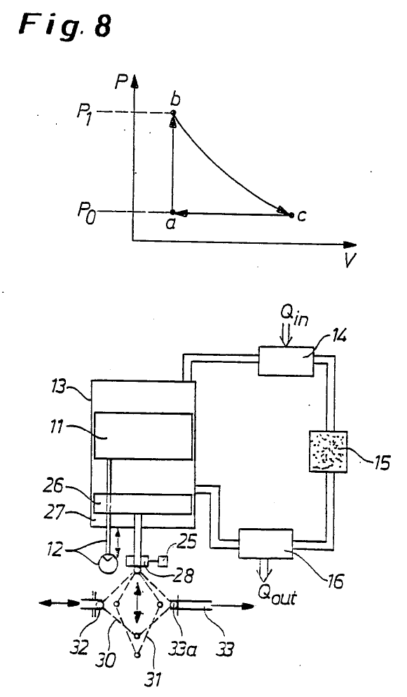

FIG. 8 illustrates such a THFA machine of the invention with linear force decoupling and linear conformator. Since in this case the subsystems require a solid working piston (instead of the heretobefore described “liquid” working piston), the advantageous implementation of this variant of the subject matter of the invention is achieved by integrating the working piston (26) in the pressure cylinder (13) and in the displacer piston (11) reciprocating therein. In this construction, the air cushion (27) beneath the working piston dispenses with the need for the expansion tank (FIG. 3, 26). The working piston, which in this case as well moves cyclically downward during the expansion phase while developing a force, is retained by the switchable shut-off element (29), which in this case is advantageously configured to be a shoe brake forming a grip around the piston rod, until the desired maximum pressure (point b in the PV indication diagram) is achieved. Then, the force is decoupled through the force conformator (30) which is geometrically configured to be a parallelogram. At its four corners, the parallelogram is fitted with rotary joints causing its form to vary permanently under the imparted movement (denoted 30, 31). If the piston rod of the desired subsystem that is to be driven with linear force is coupled in a corner point the axis of orientation of which is normal to the axis given by the working piston, the dynamic effect of the working piston of the THFA, which has an asymptotic curve from b→c because of the isothermal expansion, is conformed, meaning it is equalized over the entire working stroke. As the THFA only delivers mechanical work to the outside during the expansion, the working piston of the subsystem is adheringly connected through the piston rod (33) during expansion only, that is to say it is only “displaced” by the conformator and is loosely seated thereon at the point of separation (33a) (pressureless coupling).

In accordance with the invention, this type of construction of the THFA may also be operated with the cycle variants illustrated in the FIGS. 5 and 6 and described herein and may be optimized using the “bypass” arrangements illustrated in FIG. 7.

Since the THFA constitutes a reversible thermodynamic machine, a particularly advantageous variant of the invention consists in configuring it as a refrigerator heat pump.

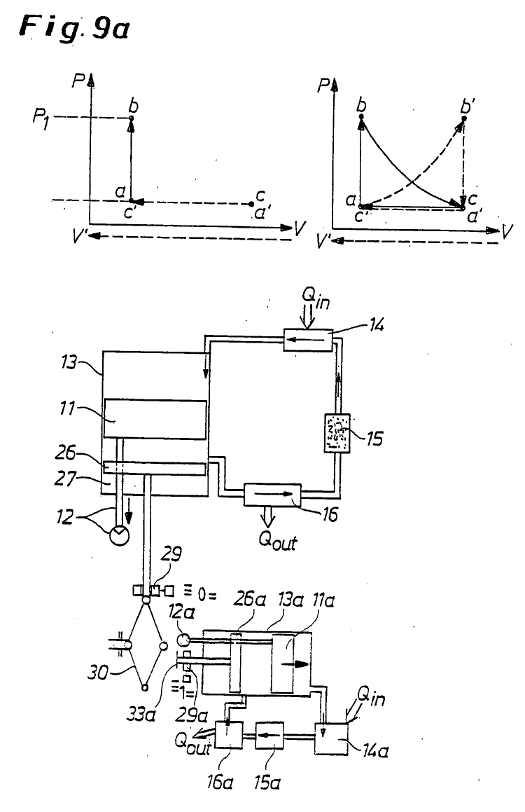

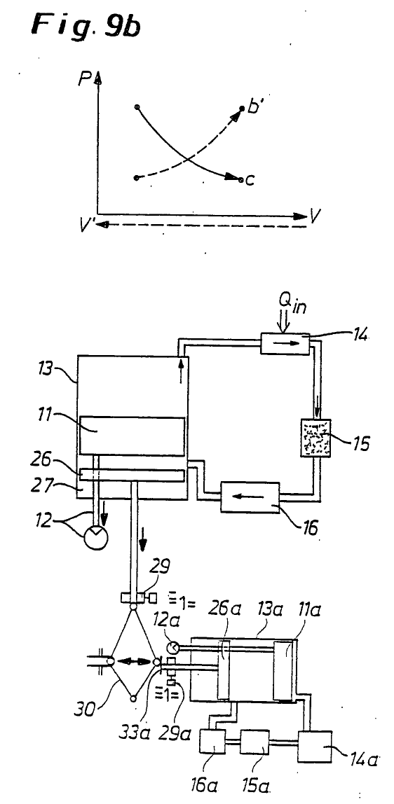

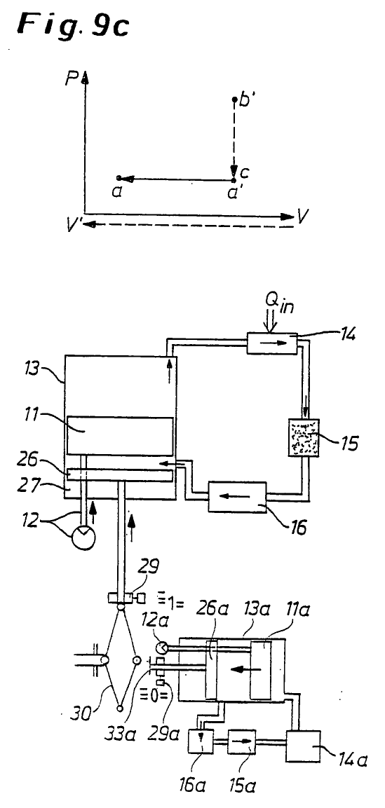

The FIGS. 9a, 9b, 9c illustrate such a THFA machine with the corresponding working steps during the three respective working phases of the driving THFA machine and the driven THFA refrigerator heat pump.

The driving THFA machine thereby has in principle the same structure as shown in FIG. 8 and as described herein above. The working piston (26a) of the driven refrigerator heat pump is cyclically pushed into the cylinder (13a) out of phase with the driving machine through the conformator mechanism (30) via the also described pressureless coupling (33a). In accordance with the invention, the refrigerator has in principle the same elements as the working machine, so that the same numerals followed by index a will be used to identify said elements (14a=heater, 15a=regenerator, 16a=cooler, 11a=displacer, 12a=linear drive of displacer piston, 29a=switchable shut-off element). In the right upper PV-diagram, FIG. 9a shows the phase offset working cycles of the THFA working machine (— line) and of the THFA refrigerator (---- line). On the left side thereof, the FIGS. 9a to 9c only show the respective corresponding working strokes of the working machine and of the refrigerator. The drawings below give some information regarding the location, the direction of movement or the standstill of the working piston and of the displacer piston of the two machines (26, 26a, 11, 11a) and the condition of the switchable shut-off elements (29, 29a). For the latter, the closed condition is denoted at ≡0= and the open condition at ≡1=.

Further, the position of the conformator (30) and of the working piston rods of the pressureless coupling (33a) is indicative of whether the working machine is driving the refrigerator or not. The fluid and the directions of movement of the pistons are illustrated by arrows.

The following happens during the three working phases:

FIG. 9a, working machine The fluid is isochorically heated from a to b. The displacer (11) moves toward the fixed working piston (26).

Refrigerator The fluid is isobarically cooled by displacing the displacer from a′ to c′. The working piston (26a) is fixed. The pressureless coupling (33a) is out of engagement.

FIG. 9b, working machine The fluid isothermally expands from b to c. The working piston (26) and the displacer piston (11) move together downward. The pressureless coupling (30) is engaged. The shut-off element (29) is open.

Refrigerator The working piston (26a) compresses the fluid. The displacer piston is fixed in the upper dead center. The shut-off element (29a) is open.

FIG. 9c working machine The fluid contracts on regenerative cooling from c to a. Working piston and displacer piston (26, 11) move upward in parallel. The shut-off element (29) is open. The pressureless coupling (30) is out of engagement.

Refrigerator The working piston (26a) is fixed in the bottom dead center by the shut-off element (29a). The displacer piston displaces the fluid from b′ to a′ (isochoric cooling).

Accordingly, the refrigerator heat pump absorbs ambient heat through (16a) (cooler), compresses the same isothermally and emits the heat again through (14a, heater). In principle, the three-stroke cycle thus performed is analogous to the cycle of the working machine described in accordance with the invention, but it is performed “in reverse” and operates at a lower temperature level.

Beside the reversible efficient cycle, it is thereby particularly advantageous that all of the heat exchange procedures can occur from liquid to liquid. As contrasted with the usual two-phase mixtures of classical refrigerators, this permits to provide much more economical and efficient cooler/heater heat exchangers. In accordance with the invention, a bypass circuit analogous to the arrangement shown in FIG. 7 (24c, 25c) may also be utilized in the refrigerator so that the cooled fluid is capable of flowing directly through the corresponding cooling bodies without clearance volume effects.

Since the driving THFA machine and the driven THFA refrigerator operate at different temperature levels, the pressures must be matched. In accordance with the invention, this may be achieved by corresponding volume ratios of the working machine cylinder (13) to the refrigerator cylinder (13a) or by accordingly reducing the pressure by means of a step working piston between the conformator (30) and the refrigerator.

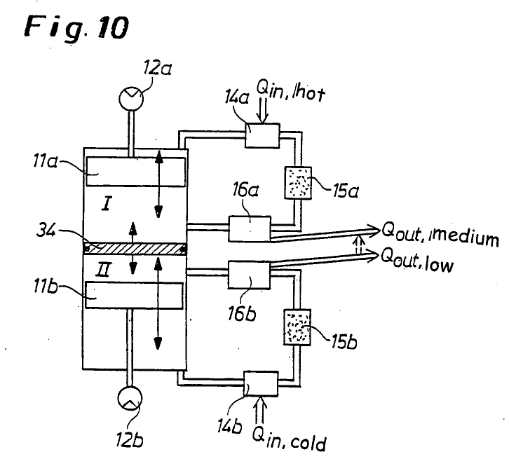

Another implementation in accordance with the invention of the THFA refrigerator heat pump makes use of the basic principle of the known Vuilleumier refrigerator heat pump operating according to the Stirling principle, adapting it to the special cycle of the THFA machine. This variant is schematically illustrated in FIG. 10.

In a common cylinder, which is divided into two working spaces by the thermally well isolated and pressure-resistant wall (34), (I=“hot” cylinder; II=“cold” cylinder), one linearly driven displacer piston with connected heater regenerator cooler path is located in a respective one of said two working spaces. The elements associated with the “hot” cylinder bear the index a, those associated with the “cold” cylinder the index b. Thanks to the time controlled valve (35) the fluids from cylinder I and from cylinder II are caused to merge when the desired time arrives for that event to happen.

At the beginning of the operation, both cylinder halves are filled with the same fluid at the same pressure (advantageously: 1 bar). The displacer drives 12a, 12b cause the displacer pistons 11a, 11b to move with a phase offset of 90°.

In the hot cylinder I, the fluid is isochorically put under high pressure by heating using 14a. Once this pressure is attained, the valve (35) is caused to open and the pressurized fluid from cylinder I compresses the fluid in cylinder II, thereby generating heat. Once the pressure has been compensated, the displacer piston (11a) moves upward in the “hot” cylinder, whereas the displacer piston in the “cold” cylinder moves downward.

The respective heat content in both the cylinder I and the cylinder II is thereby regeneratively transmitted to the regenerators 15a and 15b where they are temporarily stored for the following cycle portion. In the third working stroke, (11a) and (11b) move upward in synchronism. As soon as both have reached their upper dead center, the valve (35) closes and the cycle starts anew as described.

In principle, in this variant of the invention, the cylinder I acts as a regenerative pressure pulsator, whereas cylinder II, as the refrigerator heat pump, performs to the left the cycle of the THFA pulsator that has been performed to the right in cylinder I. Heat is thereby abstracted from a desired volume through (14b) at a low temperature (refrigerator) and is emitted again by (16c) at an average temperature level (heat pump). If operated as a heat pump or as a combined unit (generating simultaneously cold and heat), it is appropriate to connect the heat flows in series using (16c) and (16a).

In principle, the thus described “Villeumier THFA” refrigerator heat pump may also be operated without valve (35). In accordance with the invention, the valve (35) is in this case replaced by a permanent small through hole in the wall (34). In this case, the displacers (11a, 11b) are not caused to move discontinuously with a phase offset of 90 degrees but are moved continuously with a phase offset of 90 degrees. This simplified cycle of the invention however has a lower power density because of the reduced useful pressure variation. In principle, this may be compensated by an increased working frequency which however implies poorer efficiency because of the overproportionally increasing hydraulic pressure losses.

It offers the potential of a wide choice of possible working fluids. Major selection criteria are: temperature and cycle stability, strong thermal volume expansion, low compressibility, high heat capacity, cₚ considerably higher than cᵥ, high boiling points, low freezing points, ecological compatibility and costs.

Although the water used by Malone as discussed herein above has many advantages, it also has the fundamental drawback that it must be pre-pressurized to a pressure of >100 bar in order to remain liquid during the entire working cycle. Although this is realizable in principle using the THFA machines discussed herein, it makes it necessary to provide for an expansion tank and for an air chamber that are filled with said pre-pressurization.

Accordingly, in the actual prior art, synthetic oils are particularly preferred, as they allow, as already discussed, to work against atmospheric pressure and as the viscosity, temperature resistance, compressibility and other major parameters thereof can be tailored to adapt to the THFA's thermodynamics.

Since the THFA machines also operate with good efficiency in the average temperature range of from about 100° C. to about 400° C., and as the heating (and cooling) of the fluid is particularly easy to realize, the following power sources are of particular interest for operating the THFA: solar energy including night operation through thermal collectors, all of the biogenic fuels, waste heat in the temperature range of concern. THFA machines and combined THFA refrigerator heat pumps are particularly suited for force-heat coupling in buildings, for decentralized power supply with solar energy and/or with biomass and for converting (industrial) waste heat back into electric energy.

The novel cycle allows an easy and compact construction, which makes it possible to build economical systems. Thanks to the high power density of the fluids, working frequencies of clearly less than 1 Hz can be run at a reasonable weight of the system (stationary use). This not only minimizes the driving power of the displacer pistons but also increases the life of the systems.

1-19. (canceled)

20. A thermo-hydrodynamic force amplifier in which a liquid is displaced between a hot region (14) and a cold region (16) within a rigid cylinder (13) by means of a driven auxiliary piston (11) through conduits of a heater-generator-cooler arrangement (14, 15, 16) or of a heater-recuperator-cooler arrangement (14, 15, 16) so that the liquid cyclically contracts and expands, thereby providing output work (19) that in each cycle is greater than an input work (12) at the auxiliary piston (11), wherein the liquid in the arrangement (14, 15, 16) is cyclically displaced in alternating flow directions and produces the output work (19) at a separate machine (18, 33).

21. The force amplifier as set forth in claim 20, wherein the liquid produces the output work (19) during expansion, being thereby expanded to atmospheric pressure (P₀) or to a slightly higher pressure, and that the liquid is then returned to an initial state in the cycle by being caused to contract by a reversible cooling process.

22. The force amplifier as set forth in claim 20, wherein a switchable shut-off element (17) by means of which the pressure generated by the expanding column of liquid may be regulated both in terms of time and quantity.

23. The force amplifier as set forth in claim 20, wherein a working frequency that is clearly below 1 Hz.

24. The force amplifier as set forth in claim 20, wherein the separate machine (18, 33) is coupled to the output (30) of the force amplifier in such a manner that the linear work production of the cyclically expanding liquid is directly coupled into the separate machine, said separate machine (18, 33) being a linear motion energy converter, more specifically an air compressor, a pressure generator in a reverse osmosis system or the like.

25. The force amplifier as set forth in claim 20, wherein the separate machine (18, 33) is coupled to the force amplifier through a force balancer (30) and a pressure coupling (33a) and acts as a refrigerator-heat pump.

26. The force amplifier as set forth in claim 20, wherein the separate machine is a hydraulic engine (18) through which the thermally expanding liquid flows cyclically so that rotational energy (19) is generated at a shaft of the hydraulic engine.

27. The force amplifier as set forth in claim 26, wherein the liquid that cyclically expands and contracts is concurrently used as a hydraulic liquid by the hydraulic engine (18).

28. The force amplifier as set forth in claim 26, wherein an expansion tank (20) that is pressurized to atmospheric pressure (P₀) or to a slightly elevated pressure is mounted downstream of the hydraulic engine (18).
